(19) United States
(12) Patent Application Publication
(10) Pub. No.: US 2003/0110121 A1
(43) Pub. Date: Jun. 12, 2003

(54) Method for procuring and redeeming construction/operation fund for power generating equipment

(76) Inventors: Naofumi Miyamoto, Hitachi (JP); Norio Abe, Hitachi (JP); Shigeaki Namba, Hitachi (JP)

Correspondence Address: Mattingly, Stanger & Malur, P.C., 104 East Hume Avenue, Alexandria, VA, 22301, US

(21) Appl. No.: 10/278,887

(22) Filed: Oct. 24, 2002

(30) Foreign Application Priority Data
Dec. 10, 2001 (JP) 2001-376131

(51) Int. Cl. G06F 17/60

(52) U.S. Cl. 705/37; 705/36

(57) ABSTRACT

A firm which executes a power selling business by disclosing information regarding the contents of the business and constructing a power generating equipment will, at the time of starting its business, set securities or equivalent credit granting units according to the evaluated value of grants from individuals, corporations, or other associations which can provide all or part of said factors, obtain a fund by selling such securities or equivalent credit granting units to electricity consumers including companies and individuals who own equipment to consume power in a neighboring area of the power plant to be constructed, and give the discount of charge in a case where power is purchased from such business according to the value available with the securities or equivalent credit granting units, as a privilege given to a purchaser during the holding period of the fund until the fund is redeemed. Further, for the secular fluctuation in circumstances which is inherent in investors, the firm will have changes in the contract form performed rationally by using IT equipment. The present invention makes it possible to support an entrepreneur who does not have sufficient funds to construct and operate a community-based type power plant, supply power at an economical price to investors who are consumers in the community, and further provide necessary actions to deal with secular changes.

### BACKGROUND OF THE INVENTION

The present invention relates to a method for procuring and redeeming construction/operation funds for power generating equipment, and more particularly to a method for procuring and redeeming construction/operation funds, wherein, it is enabled to support an entrepreneur who has a certain level of funding ability, but does not have sufficient funds to construct a power plant to easily construct and operate a power plant as well as to maintain the community-based public interest and to provide a stable and sound management, and further, to rationally perform the construction of power generating equipment and the procurement and the redemption of operating funds as well as the contract modification by using information equipment including the Internet, while by preventing the civic life from becoming unstable caused by the wide fluctuation in the electricity charging unit simply due to investments triggered by the speculative market principle.

In recent years, in response to the strengthening social trend for deregulation in various countries, free participation in businesses has also been encouraged in the business field of power generation and selling/purchasing power, aside from the fact whether public missions are strong or weak, or they are available or not. This means that, if one has a funding ability to start up a business, any one can personally plan to build a power plant, acquire a site, construct a power plant on the site, and perform a supply business of electricity to customers having electricity demand who had been separately recruited in advance. In addition, depending on circumstances, such business is not limited to the power generating business, but it may provide different items such as gas, city water, and a public transportation facility.

It is predicted that the legislative changes stated in the above will, in terms of funding ability, expand a business chance of the strong, and will bring pressure on that of the weak. This is because it is regarded that the expense required for the construction of a “power plant” is sufficiently larger than the amount of money that is at the disposal of general individual, even though the energy output of generated power is small, and it belongs to an entity or the so-called big business.

In addition, as a well-known technology regarding the power generation business where a lot of small-lot funds are collected, for example, such technology that relates to a photovoltaic generation equipment which was inserted in the evening edition of the Asahi on Jul. 25, 1996 is known. The type of the technology is that a photovoltaic generation equipment is established with a fund invested by a plurality of citizens to sell electricity. Furthermore, the type is that citizens make small-lot investments to establish a power generation equipment, but the handling method at the time of transferring the right of securities or credit granting units for the power generating equipment has not been clarified. Therefore, when the power generating equipment is accounted for a business and not for an NPO (Non-Profitable Organization) activity to construct the equipment with the money clubbed together by voluntary citizens, it is necessary to consider the handling of the transfer of right of securities or credit granting units as well as fluctuations in their values.

A business is requested in a type where an opportunity for the weak in terms of funding ability to participate in a business can be assured even in the occurrence of a change in the business environment stated in the above, and further, the type of the business directly couples with unbroken line of daily life and activities in the area concerned, and local people can realize that the type of the business coincides with the directionality of daily life of their local public agency.

### SUMARRY OF THE INVENTION

Accordingly, an object of the present invention is to provide a method of procuring and redeeming construction/operation funds for power generating equipment, which makes it possible to provide assistance to an entrepreneur who has a certain level of funding ability, but does not have sufficient funds so as to construct and manage power generating equipment easily.

Another object of the present invention is to provide a method of procuring and redeeming construction/operation funds for power generating equipment, which enables an easy transaction by clarifying handling at the time of transferring the right of securities or credit granting units for investments to construction/operation funds, thus making the improvement/value of the liquidity of such securities or credit granting units and establishing an environment to allow general citizens to easily make investments, and also by using IT equipment, thus reducing the time restriction incurred by investors in connection with the transaction of such securities or credit granting units.

According to one aspect of the present invention, there is provided a method for procuring and redeeming a construction/operation fund for power generating equipment at the time of constructing the power generating equipment and executing power selling business. The method comprises the steps of: regarding necessary factors such as a construction fund of power plant, an operating fund, land, fuel/equipment and materials, and human resources, setting up securities or equivalent credit granting units according to evaluated value of grants from individuals, corporations, or other associations which can provide all or part of said factors; obtaining a fund by selling such securities or equivalent credit granting units to an electricity consumer who consumes power in a neighboring area of the power plant to be constructed; and giving discount of charge in a case where power is purchased from the business according to the value available with the securities or equivalent credit granting unit, as a privilege given to a purchaser during the holding period of the fund until the fund is redeemed.

Preferably, an environment is created where the transfer of the securities or the credit granting units can easily be performed in such a place opened to public that is managed under the responsibility of an operation company of a power generating equipment on the basis that several restrictions are provided to maintain the community-based relationship.

Preferably, if a person who owns the above-stated securities or the equivalent credit granting units does not execute all or part of the right to have discount of electricity charge to be purchased from a firm, such person can receive, from the firm, the redemption of value which is equivalent to the amount obtained by discounting part of the value, regarding the securities value equivalent to the portion not to be executed.

### BRIEF DESCRIPTION OF THE DRAWINGS

Other objects and advantages of the invention will become apparent from the following description of embodiments with reference to the accompanying drawings in which:

FIG. 1 is a diagram explaining an example where, an entrepreneur clearly shows the operation status of the business, and disclose information concerning the operation status of a power plant already in service to small-lot and large-lot investors, for the purpose of giving public relations to general public to obtain the construction funds;

FIG. 2 is a diagram showing an overall configuration explaining the relationship among a community-based power plant, a power network and an electricity consumer to be provided according to a preferred embodiment of the present invention;

FIG. 3 is a diagram showing a configuration which supplies steam and heated air that are generated during the power generation of a community-based power plant to be provided according to a preferred embodiment of the present invention;

FIG. 4 is a diagram explaining the concept of a contract regarding securities or equivalent credit granting units of power generation equipment to be operated according to a preferred embodiment of the present invention;

FIG. 5 is a diagram explaining a form of contract, and a concept and a method to change the contract; and

FIG. 6 is a diagram explaining an example of a procedure to change a contract by utilizing features of IT equipment.

### DETAILED DESCRIPTION OF THE PREFERRED EMBODIMENTS

Hereinafter, a method of procuring and redeeming construction/management funds for power generating equipment, and procuring and redeeming operating funds according to a preferred embodiment of the present invention will be described in details with reference to the drawings. The preferred embodiment to be described below assumes a case where, if Mr. A, an entrepreneur, has a certain level of funding ability, but the fund is not sufficient to construct and manage a power plant, Mr. A shall start up an operation company for the purpose of constructing a power plant in a local city P, and the procurement of the insufficient amount of fund is executed by the operation company to call on communities including the local city P, particularly on general community residents, to jointly participate in the business.

It should be noted, however, in the following description, terms such as an entrepreneur, a business entrepreneur and a firm will not be particularly differentiated, but they are used as such terms that have equivalent meaning each other.

Specifically, a business entrepreneur will explain details of the participation in the business at the level of an individual person, for example, the participation in the business at the level of an individual person is possible for the general community residents just by offering small-lot of funds in hands, clarify the meaning of participation and that significant social contribution is also possible concerning the local community, and further explains that it is possible to share profits among the firm and participating individuals with a stance of something like a “joint management” to avoid the case where the firm will unilaterally have profits and participating individuals will unilaterally incur losses.

The preferred embodiment according to the present invention is provided, therefore, for the purpose of enabling to assure that the business entrepreneur is performing explanation to small-lot investors by giving necessary information in an understandable manner and at necessary frequency, that the explanation is based on objective information, and further that the investors can enjoy economical advantages through participating in the business.

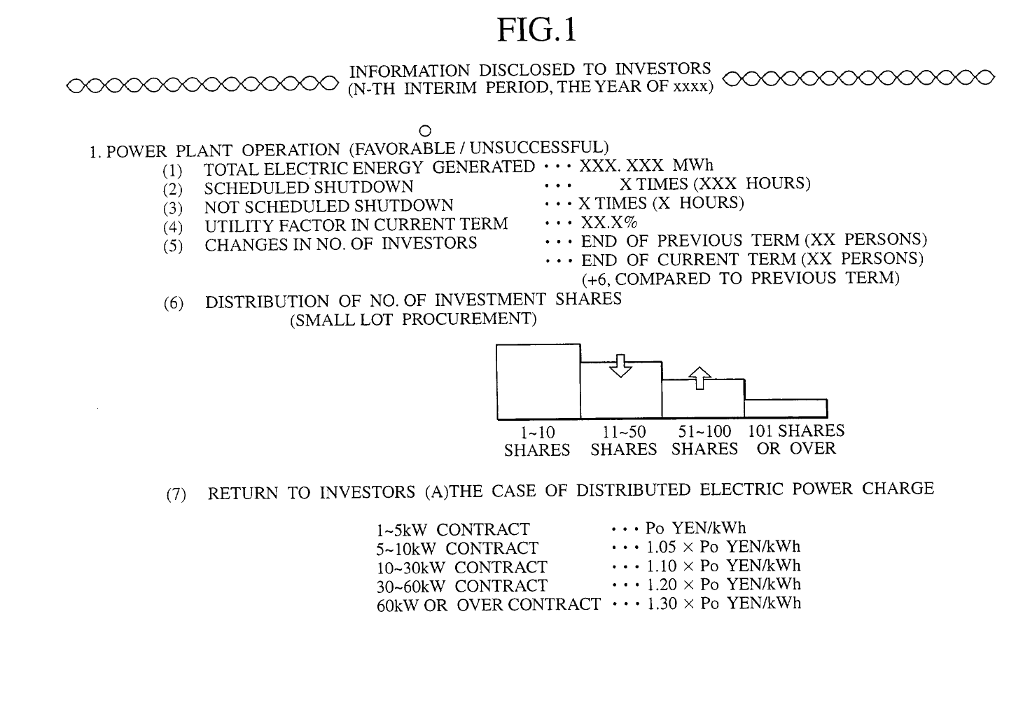

FIG. 1 is a diagram explaining an example where, an entrepreneur who is going to construct a power plant, and is going to execute a business to generate electricity and sell it clearly shows the operation status of the business, and disclose information concerning the operation status of a power plant already in service to small-lot and large-lot investors, for the purpose of giving public relations to general public to obtain the construction funds.

Although the example of information shown in FIG. 1 is titled as “information to be disclosed to investors”, the information may be used for PR at the time of recruiting new investors. In this case, the contents should be that items essential for performing business of a power plant are indicated along with accumulated record information such as electric energy and the frequency/time of unplanned shutdowns. A business entrepreneur will use such information as an evidence of fair operation by notifying the present status of operation simply and plainly, and also indicating and notifying the distribution and the trend of investors participating in the operation as well as the reality of economical return to investors.

Examples of media to be used for such indication include cable TVs, the Internet, newspapers, direct mails and telephone services. Where an investor or a person who wishes to invest is going to obtain information through the Internet by using a personal computer, the investor or the person who wishes to invest can download latest information on demand from a business entrepreneur, and the business entrepreneur enables such investor who has a positive will to obtain information to participate in the management of the business. The term “participation in the management” herein implies that an inventor offers items which have enormous impacts on managerial matters in the subjective meaning, opinions/proposals for presented trend to the president of the business. While from the viewpoint of the president of the business, the term implies that the contents of proposals, etc. from investors can be used as a trigger to make judgment whether they are in accordance with the management policy or not, whether they are indices to measure customer satisfaction or not, or whether it is necessary to reflect impacts on items/systems to be disclosed or not.

A business entrepreneur who is going to disclose information as stated in the above, construct a power generation equipment and perform a power selling business (hereinafter referred to as a “decentralized generating plant firm” or simply as a “firm”) will, prior to start the business, sets securities or equivalent credit granting units according to evaluated value of items provided by individuals, corporations or other associations which can provide all or part of factors described in the above, obtain a fund by selling such securities or equivalent credit granting units to an electricity consumer, including enterprises and individuals who own equipment that consume power in a neighboring area of the power plant to be constructed, and give discount of charge in a case where power is purchased from said firm according to the value available with said securities or equivalent credit granting units, as a privilege given to a purchaser during the holding period of the fund until the fund is redeemed.

A person who owns the securities or the equivalent credit granting units as stated in the above can, if the person does not execute all or part of the right to have discount of electricity charge to be purchased from a firm, receive, from the firm, the redemption of value which is equivalent to the amount obtained by discounting part of the value, regarding the securities value equivalent to the portion not to be executed. The person who owns the securities or the equivalent credit granting units as stated in the above can transfer it to a third party as negotiable securities, and the person who received the transfer can execute the nominal value.

In addition, in the foregoing description, if equipment and materials are set as the procurement target as the necessary factors, a third-party organization which will evaluate and authenticate subsequent service years and terms, regarding equipment and materials, can grant public and private objective guarantee information, when a firm which play the role of procuring the equipment and materials shoulder such authentication expense, and further, the third-party organization itself which makes above-stated evaluation and authentication can participate as a general procurement-related person. Furthermore, if human resources are set as the procurement target as the necessary factors, a third-party organization which will examine, evaluate and authenticate, regarding the human resources, experience in the continuation, control, maintenance, etc. of the power generating operation, or the qualification status of operating skills, can grant public and private objective guarantee information, when a firm which play the role of procuring the equipment and materials shoulder such authentication expense.

In addition, in the foregoing description, the decentralized generating plant firm, at the time of procuring respective factors, is able to have a bid called for in the manner that is advantageous for the firm itself, by using information media including the Internet, disclosing and indicating its recruiting intention for general public, and perform the conditioning of the step-by-step confirmation covering the order of priority and detailed contract according to the number of applications for the participation.

In addition, in the foregoing description, the firm, at the operation stage after the construction of a power plant, will perform the disclosure of the briefing of the operation status to owners of the credit-granting unit and to general public by using information media including the Internet. At this time, the firm, regarding the contents of the briefing of the operation status to be disclosed, can differentiate a person who owns a credit-granting unit from general public in terms of the scope, the frequency and the term of the contents to be disclosed.

In the foregoing description, the explanation is made on a case where a decentralized generating plant firm is going to construct a new power generating equipment and perform a business, and such method can apply to another case where a decentralized generating plant firm is going to expand its existing power plant. In this case, a person who owns a credit granting unit for the existing power plant, in the purchase of a right for the portion to be expanded, can make an arrangement so that the portion owned by himself or herself is handled as a financial fund and the amount that is 1 time or more of the financial fund can be handled to be a virtual financial fund and is made to be evaluated in an auction. In this case, the person can arrange that the purchase of right for the expanded portion can be executed by providing a priority quota for electricity consumers in a community.

Hereinafter, a case where a business entrepreneur Mr. A who executed the disclosure of information shown in FIG. 1 is going to establish an enterprise called Spot Power Co., Ltd. which performs power generating business, and a small-lot investor Mr. C who lives in a local city P saw the disclosed information and invested a small-lot fund will be described with reference to specific examples.

Mr. C is an ordinary office worker and has been completely unrelated to such risky economical activity as investment. However, he came to know that a power generating firm called Spot Power was moving into the town he lives, and he already invested 300,000 yen which was the amount that he could freely use at his own discretion. Mr. C, along with the investment, signed a power-buying contract from the Spot Power, and Mr. C is interrelated to the Spot Power where the power consumed in his residence depends on the Spot Power. A power generating firm can also determine a charging system depending on the number of lots of respective investors. For example, the power generating firm may recruit investors while setting the lower limit of the invested amount, based on the comparison between costs for the improvement of infrastructure of respective investors (e.g., costs to establish power networks, install watt-hour meters, and cost to maintain them) and advantages of being invested, may invoice such maintenance cost to investors who invested less than the lower limit, and of course, will not invoice cost for the improvement of infrastructure and maintenance charges to those investors who invested exceeding the lower limit, etc.

Mr. C stated above makes it a daily routine, regarding the payment of contracted power charge, to check the data of returning value to investors shown in FIG. 1. This is because, since the charge for the difference to be calculated can be paid to the Spot Power, he thinks that this will contribute to his family budget, and he checks the effect. Depending on the ratio between the invested amount and the electric energy consumed, power charge may be returned in full (value invested). In addition, depending on the steep rise of fuel used in the power plant, etc. or the obscurity of his own economic status, it is possible to appropriate the expense by collecting the fund, therefore, he can check whether the situation is economically advantageous or not. Further, Mr. C, in practicing the “civic significance” of indirectly supporting community-based economical activities, it is possible to perceive the distribution of participants in this business based on the distribution data of the number of invested lots, and watch the transition of the community-rooted power generating business.

As stated in the above, since the preferred embodiment according to the present invention allows a substantial discount of power charge according to the investment amount, the economical effect of the integration of power becomes considerable at the individual/family level in a case where the number of investment lots is large or when the right is owned for a long period of time, and this aspect, when viewed in the other way around, will work on the stabilization of the management base of the Spot Power which is an operating firm of a power generating equipment or a firm having a power generating equipment. The method stated above which will return part of the power charge as an investment return will make the power charge fluctuate, therefore, the return to investors may become unclear. Thus, the preferred embodiment according to the present invention makes calculation in more detailed computation where the power charge is calculated by (electric energy consumed)×(price at the time of use) for the payment of conventional power-buying from a power company. Thereafter, the results will be shown in graphs (abscissa axis: axis of time, axis of ordinate: difference of contribution amount, etc.), etc., and the results will be indicated to investors by means of communication means such as the Internet, thus enabling investors to confirm daily economical contributions.

Next, as an example of a consumer investor, a case of Mr. D who is a farmer living in the same community will be described. Mr. D who is a farmer is growing farm products using vinyl houses in the vicinity of a power plant, but conventionally, he has been using the sun and a private-use boiler as heat sources. Now, Mr. D, along with the commencement of operation of the power plant, changed and updated the main heat source to be the steam fed by the power plant to perform activities to produce farm products, and he appropriated five million yen including a bank loan as the investment money. As heat source medium for warming which is necessary for farm business on which he depends his living, Mr. D purchases steam generated by the power plant, and he also owes the power demand at his own home, etc. to the electric supply from the Spot Power. Therefore, he is very much concerned about the stability of the business of the Spot Power and the effective utilization of the fund he invested, and he has made it a rule to check its daily management status every morning.

Mr. D is particularly thinking of making an additional investment to next new/additional plans of the Spot Power in part through the will of expanding the business to supply fresh farm products to city dwellers, and he is now making efforts to construct public opinion for the promotion of his plan. Further, Mr. D has a background where he had an approach from the Spot Power requesting him to offer the unused land in the vicinity of his residence for the purpose of the effective use of the land during the negotiation for the securement of the construction site in the initial phase of the construction planning of the power plant, and he accepted the offer. More specifically, Mr. D actually participated in the business, considering applications according to the property value owned by himself so that he can take advantage of various resources owned by himself in his economical activities. Consequently, obtaining the value from the Spot Power by offering land will naturally allow him to enjoy the appropriate amount of interest, irrespective that the action will accompany the transfer of the ownership or not.

In addition, it shall be assumed that the example described herein refers to a case where a company E has made an investment and participated in the business of the Spot Power. The company E is not located in the city P and its participation in the business is simply by making investment to the business. Therefore, their community-based relationship with the community is not strong, but they have become a party to the Spot Power, expecting the return from the profit by investor return as well as the business profit. In such style of the participation, it is possible to make buying and selling of shares of the Spot Power or to freely execute the disposition of returned profit as an investor's right based on the will of business strategy of the company E. However, since the company E is not an actual electricity consumer concerning the portion of returned profit due to the feature of the initial community-based relationship of the Spot Power, the contract is made to allow a slight discount of the size of the profit. As for the company E, they decided such arrangement through an overall judgment that they would have profit contribution under such conditions from the short-term and long-term viewpoints.

Here, the flow of fund will be described from the side of the company E. In general, there are no grounds that the company E owns a lot of surplus funds whatever its core business is, and therefore, even if they are going to make a financial participation, a step must exist to collect funds from a financing company based on the information on the opportunity for the taking-in of business, and the funds for the business of the Spot Power which is a power generating firm will be procured according to the backup of such financial support. In this case, it shall not be questioned, here, whether a financing company will additionally insure a finance and insurance company or not. The company E, apart from the funds that the company itself has acquired, can make a contribution by means of the procurement of equipment and materials in the process of the construction of the power plant, if it has a rational capability to procure power generating equipment and materials which deeply relate to the power generating business. More specifically, in a case where it is possible to procure power generating equipment and materials owned by a third party that might have been totally unrelated before at a rational amount of money that would only be possible by the company E, the company E is possible not only to give financial involvement as stated in the above, but to directly deliver equipment and materials, and make such action to be the target of evaluation for the discount of power charge. Regarding the delivery of equipment and materials, such procuring method is possible, if the company E is familiar with the secondary market of equipment and materials which are not brand-new but are sufficiently usable and is possible to arrange and procure equipment and materials based on the official backup from an organization which guarantees and authenticates the sufficient reliability of use on the condition of their reuse.

Since the embodiment according to the present invention is a suggestion based on a premise under the situation where the starting point is the insufficiency in financial procurement, such recycling and ecological method which may be able to reduce the initial cost is well acceptable. Also, at this time, it is possible for the secondary market of equipment and materials not only to procure funds, but also to take measures including information whether the procurement of equipment and materials is available or not, or whether it is necessary or not, in addition to the disclosure information via the Internet as stated in the above. In the procurement of equipment and materials stated above, the company E shall use a company called H which evaluate the service life and reliability of such equipment and materials. The company H is a company which officially discloses the technical method to guarantee the reliability of equipment. The company features that they only handle equipment and materials whose history of use can traced back individually, and they define not only visual inspections, but also the withstand voltage test, characteristics, and times/frequency of starts and stops of equipment, evaluation data of remaining service life considering the results of voluntary tests, and control items including the designation of transitional tests as a reliability confirmation procedure until the end of the service life. They also have test reports of brand-new equipment and materials made by manufacturers, and thus they can present progress information concerning the aged deterioration to their customers. Therefore, since perfect record data are not always available for all equipment and materials, they operate to provide difference in the assessment of the reliability confirmation level depending whether such data are available or not, and they adopt a method to reflect such difference on the grading of their marketable value.

For materials to be used for the evaluation of durability of above-stated materials to be procured, for example, the following may be used:

\mathring{1} test reports of equipment and materials at the time the products are manufactured;

\mathring{2} withstand voltage tests of equipment, breakdown tests of equipment such as a water pressure test, an ultra sonic test, and a radiation test;

\mathring{3} characteristics tests of equipment;

\mathring{4} the number of starts and stops;

\mathring{5} total operation time;

\mathring{6} maintenance record information of equipment (including the replacement of parts, etc.); and

\mathring{7} environment information for the use of equipment.

Here, the item \mathring{7} environment information for the use of equipment implies, for the case of a motor used as a blower in a factory, such information that are related to temperature, humidity and dust atmosphere for that environment.

Next, a right auction in the scope where the power charge discount right of an investor can range will be described.

An investor also has restrictions and advantages in the utilization method of the right he or she owns, irrespective whether the investment is of a small-lot or a large-lot. More specifically, in a case where the investor is also an electricity consumer and wishes to request the “selling”, the investor shall be subjected to the restriction of community-based relationship because a load electricity consumer is introduced in preference within the same community, while in a case where the investor wishes to request the “buying”, the investor shall be granted a supporting subsidy at a specified amount, percentage, etc. for the nominal value by the Spot Power. Such “buying” request is a restriction to secure the community-based relationship and the permanence, and it is a method to control the speculative fluctuation aspect caused by the right auction within an adequate scope.

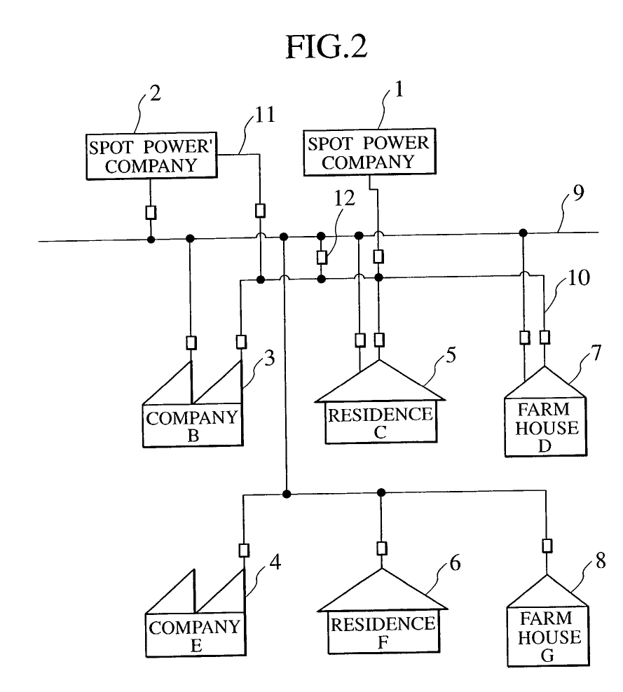

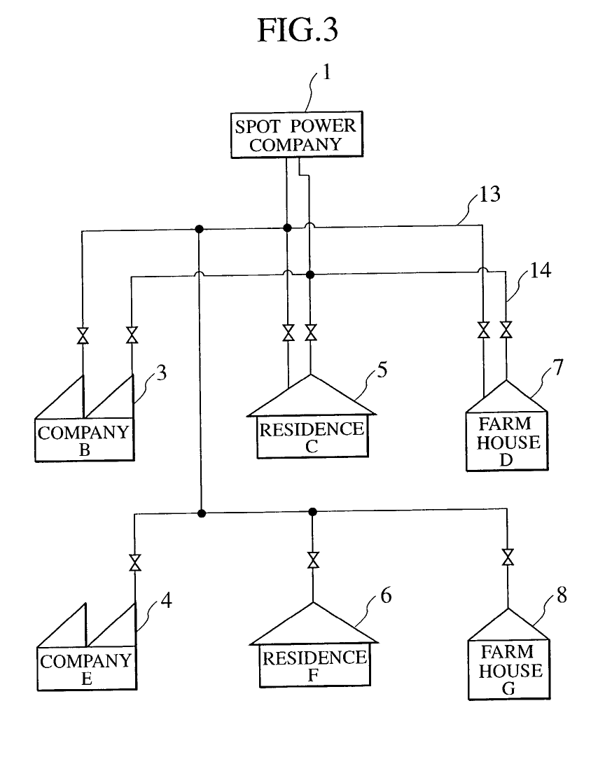

FIG. 2 is a diagram showing an overall configuration explaining the relationship among a community-based power plant, a power network and an electricity consumer to be provided according to a preferred embodiment of the present invention, and FIG. 3 is a diagram showing a configuration which supplies steam and heated air that are generated during the power generation of a community-based power plant to be provided according to the embodiment of the present invention. In FIGS. 2 and 3, reference number 1 is Spot Power Company A, 2 is Spot Power Company A′, 3 and 4 are large-lot consumer B and company E respectively, 5 and 6 are small-lot consumer C and residence F respectively, 7 and 8 are farm houses D and G respectively, 9 is a power network, 10 is a power distribution network, 12 is a power cable, and 13 is a pipe for steam/heated air.

In FIGS. 2 and 3, Spot Power companies A1 and A′2 are community-based power plant firm, and they supply power to company B 3, residence C 5 and farm house D 7. Company B 3 which is a large-lot consumer, residence C 5 and farm house D 7 are investors to the Spot Power Company. The Spot Power Company A′ may be a case where it is financially related to the Spot Power Company, a case where the power plant is the one constructed by themselves in an another area, a case where the power plant is completely different one which performs similar business under different funds, etc., and further, it may or may not exist in plurality. The power network 9 shown in FIG. 2 is a power network maintained by a major power company, and the power distribution network 10 which distributes power to respective policyholders from the Spot Power Company under the contract with the Spot Power Companies A1 and A′2 is independent from the power network 9.

An example shown in FIG. 2 shows a case where the company B 3, residence C 5 and the farm house D 7 receive the supply of power from the Spot Power Companies A1 and A′2, and the company E 4, the residence F 6 and the farm house G receive the supply of power from the major power company. With the example shown, power generating equipment of the Spot Power Companies A1 and A′2 are connected to the power network 9 which are maintained by the major power company via an exclusive line 11 so as to enable mutual provision of power. Due to such arrangement, even if the power network 9 is shutdown, the Spot Power Companies A1 and A′2 can mutually provide power, and therefore, in case where the Spot Power Company A1 can not cover the full power supply to policyholders of the Spot Power Company, it is able to have power supply from the Spot Power Company A′2, and also, it can receive power from the major power company. In addition, should an accident occur, to prevent the accident from developing to others, the exclusive line is provided with a function to automatically or manually disconnect either power generating equipment in which an accident has occurred. For this purpose, a power line 12 connects both the power network 9 and the power distribution network 10 to enable the transmission and the reception of power mutually, and it is provided with a function to disconnect the power line should any accident such as a power failure in either of the power network 9 or the power distribution network 10 occur. Due to the function, even if power failure occurs in the other power network due to an accident, etc., the power network 9 and the power distribution network 10 can be independent to continuously supply power by disconnecting the power line.

In addition, as shown in FIG. 3, a Spot Power Company A1 can supply steam and heated air which are generated during the power generation to companies B, E which are large-lot consumers, residences C, F, and farm houses D, G which are small-lot consumers by using pipes 13 and 14 for steam/heated air.

By building the above-stated infrastructure, a normal policyholder can receive power supply form the Spot Power Company. If the Spot Power Company becomes unable to supply power through the power distribution network 10 due to accidents such as lightning and shutdown of power plant (Spot Power Company), power can be supplied to consumers from the major power company via the power network 9. Note that, in this case, it will be so arranged that the Spot Power Company buys power from the major power company and supplies the power to policyholders.

In addition, if the power transmission by using the power network 9 of a major power company becomes impossible for any reason, a policyholder can receive the supply of power from the Spot Power Company, thus enabling to reduce a risk (the shutdown of computers or various machines) caused by the stoppage of supplying power.

The above-stated preferred embodiment according to the present invention has an advantage that it can decrease the possibility of stoppage of power supply, but since it requires to install a new power network, it has a disadvantage at the same time that consumers are limited to policyholders located in the vicinity of the power plant. However, if policyholders find any advantage by installing a privately owned electrical power facility and comparing the cost for maintenance services, it will be chosen. The contract will be mainly chosen and performed by a firm which consumes significant amount of power, and therefore the cost will be paid off even if an exclusive line is installed to avoid any risks arising out of power failure. In addition, in the case of general households, if residents in a housing complex such as an apartment are going to make a lump sum contract, the cost of installing an exclusive line per residence can be reduced by installing a power network to the apartment, and distributing power to individual home, after comparing it with the power network of a major power company.

With the above-stated preferred embodiment according to the present invention, it is possible to supply power to consumers not by using the exclusive power distributing network 10, but by using, from the Spot Power Company, the power network 9 of a major power company. In this case, if the power network 9 of the major power company is shutdown, the circuit-breaker of the power line 12 will be opened so as not to cause a power failure at the consumers of the Spot Power Company being affected by the power network 9. With such arrangement, even if the Spot Power Company is generating power in a normal manner, those policyholders who are receiving power through the power network of the major power company will not be able to receive power from the Spot Power Company, but they will suffer from power failure. However, since they do not have to install an exclusive power network, the cost can be suppressed to a lower level, thus enabling to prevent the price of power from being increased. With the contract, since the reliability of the power supply cannot be enhanced, those persons of general households, for example, who will not incur damage due to a temporary power failure will chose the contract since the price of power is economical.

Next, an application of the preferred embodiment according to the present invention in a case of a newly developed residential district, an industrial park, etc. where the power network has not been arranged at all will be described. In a case where the power network 9 of a major power company has not been arranged, and the power distributing network 10 has not been arranged, though a community-based power plant firm such as the Spot Power Company is located nearby the site, a policyholder who is going to receive the supply of power must be required to install an exclusive power line. Of course, the reliability of power will decrease when compared to the case where a power network by a major power company is available, but for the case of an isolated island which is far from the power network of a major power company, the configuration must be the one stated above. In addition, it is predicted that the configuration will also apply in developing countries where power networks have not been provided sufficiently.

Next, the supply of steam (heated air) will be described. As for steam (heated air), discharged heat that is generated during the power generation is supplied to policyholders, and it is mainly used for heating purposes, and particularly in the case of a farm house, it is used for heating purpose of plastic greenhouses. In this case, it is possible to supply steam to consumers located in the vicinity of the power plant, but, since drain will be generated in pipes at end areas when the total length of pipes are long, the supply of heat in the form of steam will become impossible. In such case, heated air will be supplied. Further, depending on the contract, it is possible to supply heated air even if the site is in the vicinity of the power plant. With the example shown in FIG. 3, steam and heated air are supplied to consumers by using independent pipes by installing a steam pipe 14 and a heated air pipe 13. Both steam and heated air are supplied to the company B, residence C and farm house D which are consumers located in the vicinity of the power plant, and only heated air is supplied to the company E, residence F and farm house G which are consumers located far from the power plant.

The advantage of supplying steam (heated air) as stated in the above is that the sales of the Spot Power Company can be expected by supplying waste heat which are unnecessary for the Spot Power Company for heating purpose, while, the advantage for policyholders is that heat source for heating purpose which is economical to them is available. In addition, when viewed from the environmental aspect, the advantage is that the reduction in CO2 emission is possible by re-using unnecessary heat. However, since the supply of heat such as steam and heated air will require the installation of exclusive pipes. When the burden of such installation is taken into consideration, the advantage will become larger when large-lot consumers are receiving the supply, and it would appear that independent advantage will hardly be available for small-lot consumers such as general households. However, in a case of a housing complex like an apartment, if a lump sum contract is being executed, they can be used as heat sources for bath or shower even in a season when heating is not necessary, thus enabling to enjoy profits which pays off the costs.

Information about power consumption and calorie consumption by respective policyholders in the supply of power and heat as stated in the above are measured with a measuring instrument provided at the site of respective policyholders, and are then transmitted to the Spot Power Company via communication lines. The Spot Power Company can calculate the entire amount of power consumption and calorie consumption by all policyholders just by accumulating the information. The Spot Power Company calculates surplus power based on the entire amount of power consumption and the power generating capacity of the Spot Power Company itself, and it can supply power also to policyholders of a major power company upon the request of the increased electricity generated from the major power company. Such situation of supplying surplus power to a major power company is expected at the time when the power consumption reaches the peak mainly in summer and winter seasons. Thus, by using the function to supply surplus power, a major power company does not require to have any additional power generating equipment, thereby enabling to reduce the maintenance service expenses required for its fixed assets.

In addition, since the Spot Power Company A can calculate the entire amount of power consumed by policyholders, it can grasp its own surplus power, and therefore, it can deploy its business more advantageously by exchanging information on the surplus power with the Spot Power Company A′ which runs similar business as the Spot Power Company. This is because, for example, if power generation is shut down to inspect the equipment of the Spot Power Company A, it will become possible that the supply of necessary power for policyholders of the Spot Power Company A is carried out for the Spot Power Company A′, and thus Spot Power Company A can deal with such action without buying power from a major power company. With such arrangement, the Spot Power Company A can suppress the cost for buying power to a low level, and thus it can offer much more return to its policyholders. Of course, if the Spot Power Company A′ shut downs power to inspect the equipment, the Spot Power Company A will supply power to the Spot Power Company A′.

The mutual provision of power between the Spot Power Company A and the Spot Power Company A′ as stated above includes two cases; one is that the power network 9 to be arranged by a major power company, and the other is that both of the power plant of the Spot Power Company A and that of the Spot Power Company A′ are connected with the exclusive line 11. In a case where the distance between both of the power plants is short, by installing the exclusive line 11, customers of the Spot Power Company A can receive the supply of power from the Spot Power Company A′ through the exclusive line 11 even if the power network 9 of the major power company is shut down due to an accident while the equipment of the Spot Power Company A is being inspected and therefore they are receiving the supply of power from the Spot Power Company A′. In addition, even in case where the Spot Power Company A′ stops the power generation due to an accident while the equipment of the Spot Power Company A is being inspected, the supply of power can be received through the power network 9 of the major power company, and therefore, the reliability of power will not be deteriorated even while the equipment is being inspected. On the other hand, in a case where an exclusive line is not installed, since power transmission is executed from the Spot Power Company A′ through the power network 9 while the equipment of the Spot Power Company A is being inspected, if the power network 9 of the major power company is shut down, the power transmission cannot be executed, and therefore, the transmission of electricity to policyholders will become impossible. However, since the installation of an exclusive line requires costs, the decision on which configuration should be employed may be made by selecting whether to install an exclusive line or to use the power network of the major power company, depending on the distance of the exclusive line for the case of installing the exclusive line and the contents of the contract with policyholders regarding the power failure.

It should be noted that, the embodiment according to the present invention has been described assuming the case where the Spot Power Company A and the Spot Power Company A′ exist as persons who operate a community-based type power plant, and each individual company has one power plant. However, more numbers of such persons who operate the community-based type power plant may exist, and one company may operate a plurality of power plants. In this case, it becomes possible that, at the time of the shutdown of a power generation equipment, the supply of such power can be shared among a plurality of power plants.

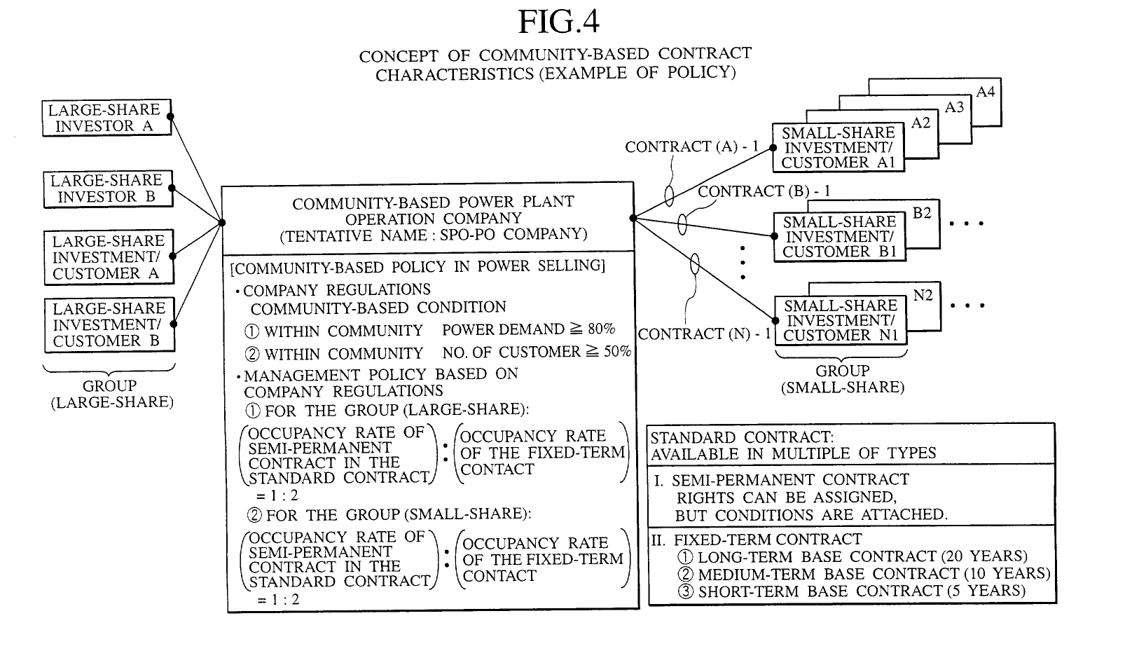

FIG. 4 is a diagram explaining the concept of a contract regarding securities or equivalent credit granting units of a power generation equipment to be operated according to a preferred embodiment of the present invention, and the concept will be described below.

In FIG. 4, a company (tentative name: Spo-Po Company) which operates a power plant, at the time of operating the power plant, has set a numerical target, as indices to indicate the degree of involvement in the community, for the percentage of electricity consumer among owners of right and the percentage that the location of the owners of right is in the area where power from the power plant which is operated by the company can be supplied. In the case of the example shown in the figure, power supplied to targets to be consumed within the community is assumed to be 80% or more of the total generating capacity, and the conditions to successfully secure the involvement in the community is assumed to be 50% of the number of consumer lots within the community. By such definition, the governing demand in the entire market can be identified within the community, and it is possible to alleviate the anxiety to be the target of speculation from outside. For this purpose, the Spo-Po Company will define the management policy to deeply root in the community and develop along with the community, thus soliciting the sense of kinship among local residents and companies as well as making a declaration to contribute to the community.

In addition, the operating company has issued a plurality of types of right in the form of a semi-permanent contract and a contract with a limit time so that consumers can make investments in either or both of them. With such arrangement, the company is able to expect investments from more number of investors (general consumers) and collect funds. In this case, regarding the semi-permanent contract, it is necessary to make arrangement to prevent the securities and credit granting units of the power plant from being the target of speculation, by providing conditions, regarding the transfer of right, for example, that the right should be resold to consumers within the community, and for this purpose, it is recommended that a firm (Spo-Po Company) should intervene the transfer in terms of supervising any unfair arrangements.

In addition, regarding the contract with a limit time, the operating company can arrange that respective consumers can make investments according to their needs by preparing several types of contract such as a long-term base contract (20 years), a short-term base contract (5 years), etc., and the company can make differentiation that the rate of power discount is set higher for the long-term contract, or set lower for the short-term contract. From the side of a firm, the long-term contract has an advantage of stabilized management since the mobilization of capital can be reduced in this case. For this purpose, principally, the firm will give a preferential treatment to the long-term contract. Further, in order to perform the community-based and stable management, the operating company shall, as the management policy of the company, introduce indices to the occupation rate of the semi-permanent contracts and that of the contract with a time limit, and shall procure a certain percentage of funds by means of the semi-permanent contract.

However, depending on the circumstances of investors (consumers), situations that require changes in contracts will occur. For example, a case where an investor has to live in places outside the power-supplying area of the power plant he or she operates due to job transfers, or a case where an investor is dead due to an accident and cash is necessary under unavoidable circumstances. In addition, adversely, such a case may be possible where, since an investor has extra funds, the investor wishes to change a short-term contract to a long-term contract and requests additional benefits such as discount of power charge.

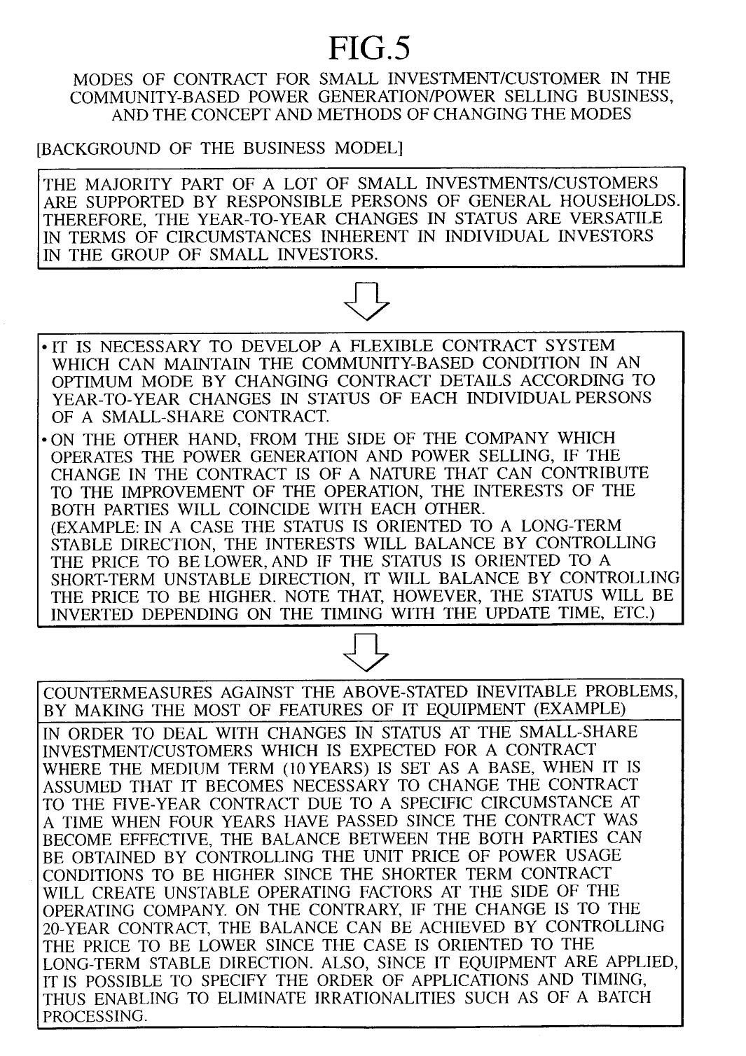

FIG. 5 is a diagram explaining a form of contract, and a concept and a method to change the contract, which will be described below. As already stated in the above, since a change in a contract due to the circumstances of an investor can be assumed in advance, a firm is required to have flexible system of contract which enables stable management and can maintain the community-base relationship in an optimum form even if a person to change the contract appears.

If the contents of the change of a contract are such that it can contribute to the improvement of management from the side of a firm, the interest with investors will coincide. For example, such a case where a short-term contract will be changed to a longer-term contract, a case where contract moneys will be returned to consumers when the management of business is running smooth and extra funds are available in hand, etc. In addition, in such a case where part of operations is planned to be shutdown due to the necessity of partial maintenance service of power generating equipment, making the contract term shorter may be an advantage to the business in terms of alleviating the duty of supplying power.

The update of the contents of contract as stated in the above is executed by constantly presenting necessary information (benefits of respective contracts and price of securities) from the side of the firm on the home page by utilizing IT equipment, and by improving the environment which enables the acceptance, etc. of selling, purchasing and changes in contract from policyholders. In addition, regarding information to be presented, if changes in contract occur, the circumstances at the firm will accordingly change, therefore, prices of securities and benefits of respective contracts will be updated from time to time to the latest ones.

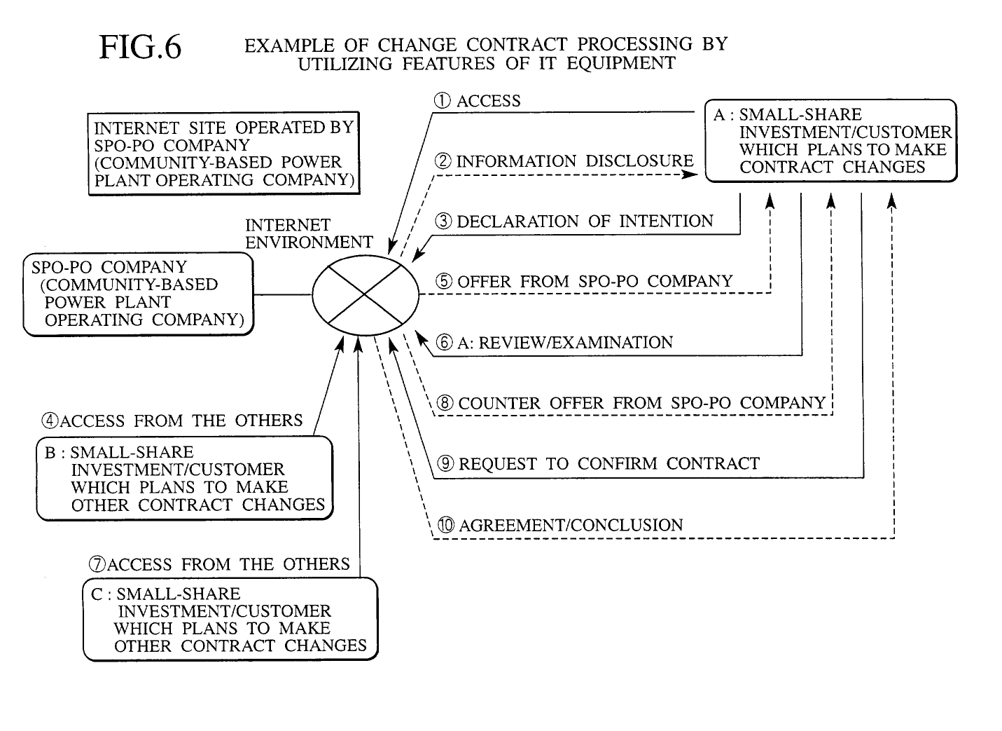

FIG. 6 is a diagram explaining an example of a procedure to change a contract by utilizing features of IT equipment, which will be described below. In FIG. 6, the transition of procedures to change a contract is shown in the order of reference numbers of \mathring{1} to \mathring{10}, and the numbers \mathring{4} and \mathring{7} show the existence of access from another person. This is because, depending on the timing of determining the first-come priority, there could be a situation where, as an effect to the contents of a contract between a firm and a consumer, the result of changes in the previous contract between another consumer and a firm.

Further, although not shown in FIG. 6, the Spo-Po Company opened their Web pages on the Internet, and the company discloses the management status/outlook, the status of power generation, power buying tariff, etc. on the Web page. They make it a rule that information to be disclosed depend on whether consumers making accesses to the Web page have the securities of the Spo-Po Company or not, and if they do, they can browse much more information than those who do not have the securities. Basically, consumers and investors can collect information or make applications and changes for their contracts by using the Web page.

Here, it is assumed that Mr. H shall be an investor who wishes to make a change in his contract, and at the same time, Mr. I and Mr. J wish to change their contracts. Since it became necessary for Mr. H to have the funds returned earlier from a firm, he is planning to change the contract with a time limit of 10 years to that of 5 years, and also change the contract so that the funds will be returned next year since four years has passed since the contract was made.

When the change in the contract is made, since Mr. H changed the contract term to 5 years, though he had been receiving the benefit of discounted power charge under the 10 years contract term, he should retrospectively pay the balance of the benefit of discounted power charge between 10 years and 5 years. Even in this case, the power charge will be cheaper than to use power in normal way, and Mr. H is satisfied with the change.

However, at the time when Mr. H was going to make a series of arrangements to change the contract covering the reference numbers \mathring{1} to \mathring{10} shown in FIG. 6, irrespective that he wished to cancel the contract this year, he postponed the time to return the funds and decided to cancel the contract after 5 years since the amount of the discounted power charge benefit is different between the contract terms of 4 years and 5 years. As described in the above, basically, the environment has been arranged so that various procedures can be done through the Web page. Therefore, Mr. H could change his contract after finishing his work and by using his free time after coming home, and he never interfered his job assignments, etc.

Mr. I and Mr. J are also consumers who wish to change their contract, and they are going to change their contract by using the Web page. In this case, because Mr. H already finished to change his contract, the management status at the Spo-Po Company has changed in terms of the contracted power and the fund in hand. If the change in the contract is of a small-lot, such change can be disregarded, but if it is of a large-lot, the Spo-Po Company will review the contents of the Web page, and take actions such as to degrade the benefit of discounted power charge for the new investments in the case of soliciting for new investments where the benefit of discounted power charge is reviewed as appropriate, or at the time when the contracted power is nearing the rated capacity of the power generating equipment.

Consequently, even if Mr. I and Mr. J are changing their contract in the same way as Mr. H, it may not always be possible that they can change their contracts under the same conditions, and sometimes, the conditions may be better or worse depending on the situation. In addition, as stated in the above, since it is possible to simplify and speed up the treatment procedures of investors as well as to identify the order of incoming data than the case of procedures by mails because information equipment is applied via the Internet, the paperwork at the Spo-Po Company can achieve the control precisely in accordance with the application quota. Therefore, the processing of the application order from consumers will never be reversed, thus enabling to reduce the work load for the treatment of complaints during the paperwork stage.

As described in the above, according to the present invention, it is possible to support an entrepreneur, who has a certain level of funding ability, but does not have sufficient funds, to easily construct and operate a community-based type power plant, and if a consumer such as a local resident becomes an investor, such consumer can receive the supply of power at an economical price. Further, according to the present invention, it is possible to flexibly deal with a request for the change in midstream that can be assumed as a secular change in circumstance from the start point of the initial operation, and in particular, it is possible to make the contract to be arranged considering the position of small-lot investors living in the community.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A method for procuring and redeeming a construction/operation fund for power generating equipment at the time of constructing the power generating equipment and executing power selling business, said method comprising the steps of:
regarding necessary factors such as a construction fund of power plant, an operating fund, land, fuel/equipment and materials, and human resources, setting up securities or equivalent credit granting units according to evaluated value of grants from individuals, corporations, or other associations which can provide all or part of said factors;
obtaining a fund by selling such securities or equivalent credit granting units to an electricity consumer who consumes power in a neighboring area of the power plant to be constructed; and
giving discount of charge in a case where power is purchased from said business according to the value available with said securities or equivalent credit granting unit, as a privilege given to a purchaser during the holding period of the fund until the fund is redeemed.

2. A method for procuring and redeeming a construction/operation fund for power generating equipment according to claim 1, wherein, in a case a person who possesses said securities or equivalent credit granting units does not execute all or part of the right to have a discounted charge of power to be purchased from a firm, regarding the securities value equivalent to the part not to be executed, the value equivalent to the amount obtained by subtracting a part of such value will be redeemed.

3. A method for procuring and redeeming a construction/operation fund for power generating equipment according to claim 1, wherein, said securities or equivalent credit granting units are transferable to a third party as marketable securities, and the par value is executable.

4. A method for procuring and redeeming a construction/operation fund for power generating equipment according to claim 1, wherein, in a case where equipment and materials are objectives of procurement as said necessary factors, a third-party organization which evaluates or authenticate the subsequent durable years or period of such equipment and materials will grant public or private objective guarantee information by allowing the firm to shoulder such authentication expense.

5. A method for procuring and redeeming a construction/operation fund for power generating equipment according to claim 4, wherein, said third-party organization itself participates in the business as a person related to the entire procurement.

6. A method for procuring and redeeming a construction/operation fund for power generating equipment according to claim 1, wherein, in a case where a human resource is an objective of the procurement as said necessary factors, a third-party organization which examines, evaluates or authenticates experience or qualification in the retention, control, maintenance, etc. of power generation operation, and the possessing status of operation skills of such human resource will grant public or private objective guarantee information by allowing the firm to shoulder such authentication expense.

7. A method for procuring and redeeming a construction/operation fund for power generating equipment according to claim 1, wherein, at the time of procuring said necessary factors, a bid is called for by publicly indicating the intention of recruitment of general public through information media including the Internet, and by performing the conditioning of a step-by-step confirmation reaching the order of priority and detailed contract according to the number of applications for the participation.

8. A method for procuring and redeeming a construction/operation fund for power generating equipment according to claim 1, wherein, at the operation stage after the construction of a power plant, disclosure of a briefing of the operation status to owners of the credit granting unit and to general public is performed by using information media including the Internet.

9. A method for procuring and redeeming a construction/operation fund for power generating equipment according to claim 8, wherein, different leads are given to details of said briefing of operation status to be disclosed in the range, the frequency and the period of time thereof between the owners of credit granting unit and general public.

10. A method for procuring and redeeming a construction/operation fund for power generating equipment at the time of executing a power selling business by expanding an existing power plant, said method comprising the steps of:
regarding necessary factors such as a construction fund of power plant, an operating fund, land, fuel/equipment and materials, and human resources, setting up securities or equivalent credit granting units according to evaluated value of grants from individuals, corporations, or other associations which can provide all or part of said factors;
obtaining a fund by selling such securities or equivalent credit granting units to an electricity consumer who consumes power in a neighboring area of the power plant to be constructed; and
giving discount of charge in a case where power is purchased from said business according to the value available with said securities or equivalent credit granting unit, as a privilege given to a purchaser during the holding period of the fund until the fund is redeemed.

11. A method for procuring and redeeming a construction/operation fund for power generating equipment according to claim 10, wherein, in the purchase of right for the expanded portion by the owner of the credit granting unit according to claim 1 which refers to the existing power plant, the owned portion is assumed to be the financial fund, the amount that is 1 time or more of the financial fund is handled to be a virtual financial fund and is made to be evaluated in an auction.

12. A method for procuring and redeeming a construction/operation fund for power generating equipment according to claim 11, wherein the purchase of right for said expanded portion has a priority quota for electricity consumers in a community.

13. A method for procuring and redeeming a construction/operation fund for power generating equipment according to claim 1, wherein, a power distribution network which is independent from existing power networks and directly connects said power generating equipment and investors with a power cable, and said power generating equipment feeds power to said investors in preference should a power failure occur in an existing power network to which said investors belong.

14. A method for procuring and redeeming a construction/operation fund for power generating equipment according to claim 1, wherein said power generating equipment feeds steam/heated air to be generated at the time of power generation to consumers via pipeline equipment.

15. A method for procuring and redeeming a construction/operation fund for power generating equipment according to claim 1, wherein, at the time when a firm is going to sell said securities or equivalent credit granting unit, a certain difference will be given to a price of the credit granting unit and the purchasing right depending on whether the selling destination is a consumer of said power generating equipment or not.

16. A method for procuring and redeeming a construction/operation fund for power generating equipment according to claim 1, wherein, in a case where said securities or equivalent credit granting units are issued as a contract with a limited term and a purchaser will change the period of contract with a firm, taking into consideration management status, operating status of the power plant, details of change for the period of contract, and possessing status of other contractors, the firm will review benefits to the purchaser, disclose then-available variable contractual coverage via information equipment including the Internet, thus enabling procedures for contract modification which retains ordered timing method through said information equipment.

17. A method for procuring and redeeming a construction/operation fund for power generating equipment according to claim 16, wherein, said management status of the firm includes that the specified percentage of securities or equivalent credit granting units which are issued by a firm and owned by local consumers as a portion of the total number thereof is maintained as a restriction to retain the community-based relationship, or that the specified percentage of the same as a portion of possible production of electricity.

18. A method for procuring and redeeming a construction/operation fund for power generating equipment according to claim 1, wherein, at the time when said securities or equivalent credit granting units are issued as a semi-permanent contract and a purchaser is going to transfer the right, the transfer destination is determined to be consumers of said power plant or a firm itself under the agreement with the firm.

19. A method for procuring and redeeming a construction/operation fund for power generating equipment according to claim 1, wherein, a firm will issue a plurality of contract types of a contract with limited period and a semi-permanent contract for said securities or equivalent credit granting units, and a purchaser will select and purchase either of them depending of its purpose.

20. A method for procuring and redeeming a construction/operation fund for power generating equipment according to claim 4, wherein, the evaluation on durability of procured equipment and materials is performed by using all or part of:
\mathring{1} a test report of a product at the time of manufacturing the equipment and materials;
\mathring{2} a withstand voltage test of equipment, a breakdown test such as a hydraulic pressure test, an ultra sonic test and an irradiation test;
\mathring{3} a characteristics test of equipment;
\mathring{4} the number of starts and stops;
\mathring{5} total operation time;
\mathring{6} information on the maintenance record of equipment (including replacement of parts, etc.); and
\mathring{7} information on the operating environment of equipment.
